(19) United States
(12) Patent Application Publication
(10) Pub. No.: US 2006/0151554 A1
(43) Pub. Date: Jul. 13, 2006

(54) Bin for a roof rack

(75) Inventors: Nicholas Bulski, Casco, MI (US); Matthew Tier, Brighton, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Nissan Technical Center North America, Inc.

(21) Appl. No.: 11/031,872

(22) Filed: Jan. 7, 2005

(51) Int. Cl. B60R 9/055

(52) U.S. Cl. 224/328; 224/316

(57) ABSTRACT

A roof rack system for a vehicle is provided that has a vehicle roof rack and a storage bin connected to the vehicle roof rack. The storage bin has a bin portion with an opening and an interior portion and a closure member having a hinge portion such that the closure member selectively covers the opening and provides access to the interior portion of the bin portion. The hinge portion is positioned in an upwind location with respect to a presumed wind direction such that the closure member opens towards the presumed wind direction to allow access into the interior portion.

### BACKGROUND

Roof rack systems are commonly used on some types of motor vehicles, such as sport utility vehicles. Such roof rack systems are typically used to carry a variety of items, such as luggage, boxes, bicycles, and other large sporting gear.

### BRIEF DESCRIPTION OF THE DRAWINGS

The present invention will now be described, by way of example, with reference to the accompanying drawings, in which:

FIG. 1 is a perspective view of an embodiment of the invention;

FIG. 2 is a perspective view of an embodiment of the invention;

FIG. 3 is a plan view of an embodiment of the invention;

FIG. 4 is a schematic view of an embodiment of the invention;

FIG. 5 is a schematic view of an embodiment of the invention;

FIG. 6 is a schematic view of an embodiment of the invention;

FIG. 7 is a schematic view of an embodiment of the invention; and

FIG. 8 is a schematic view of an embodiment of the invention.

### DETAILED DESCRIPTION

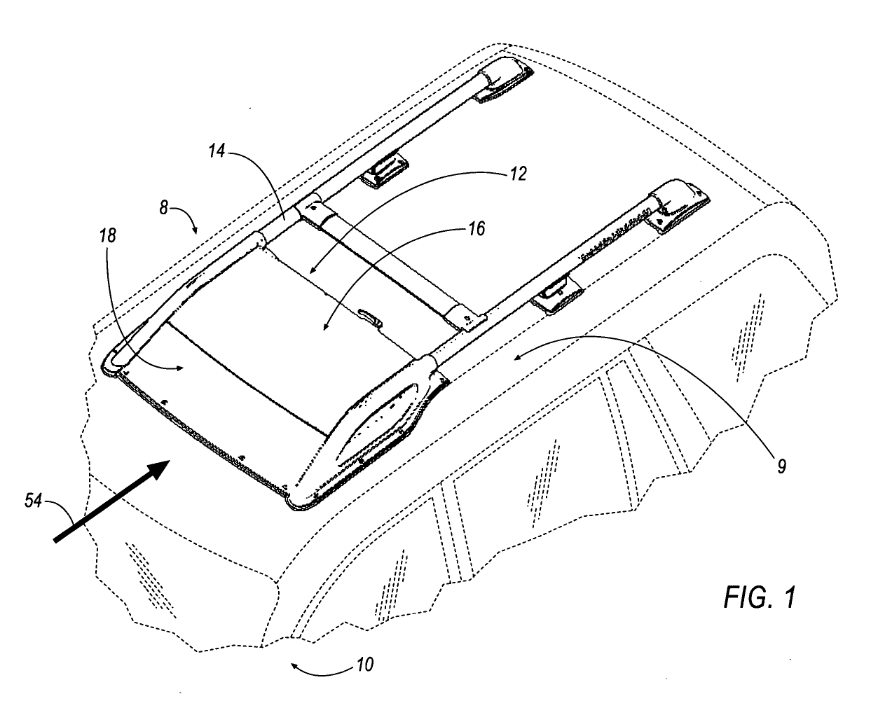

Referring now to FIG. 1, a roof rack system 8 according to an embodiment of the present invention is shown and described. In FIG. 1, the roof rack system 8 generally includes a storage bin 12 connected to a roof rack 14. As shown, the roof rack 14 is connected to a roof portion 9 of a vehicle 10. Intricacies of the roof rack system 8 as well as the interrelationship between the storage bin 12, roof rack 14 and roof portion 9 may include features as understood by one skilled in the art and may also include features disclosed in U.S. Pat. No. 6,561,397 B1, issued on May 13, 2003 and assigned to Nissan Design America, Inc., the entirety of which is incorporated herein by reference.

In FIG. 1 and in the remaining Figures, the roof rack system 8 is shown oriented with respect to a presumed wind direction 54. The presumed wind direction 54 is an assumed direction from which wind flows when the vehicle, on which the roof rack system 8 is attached, moves. However, one skilled in the art will readily recognize that the described embodiments may have different orientations with respect to the wind direction 54 and the embodiments of the present invention are not limited to that disclosed herein.

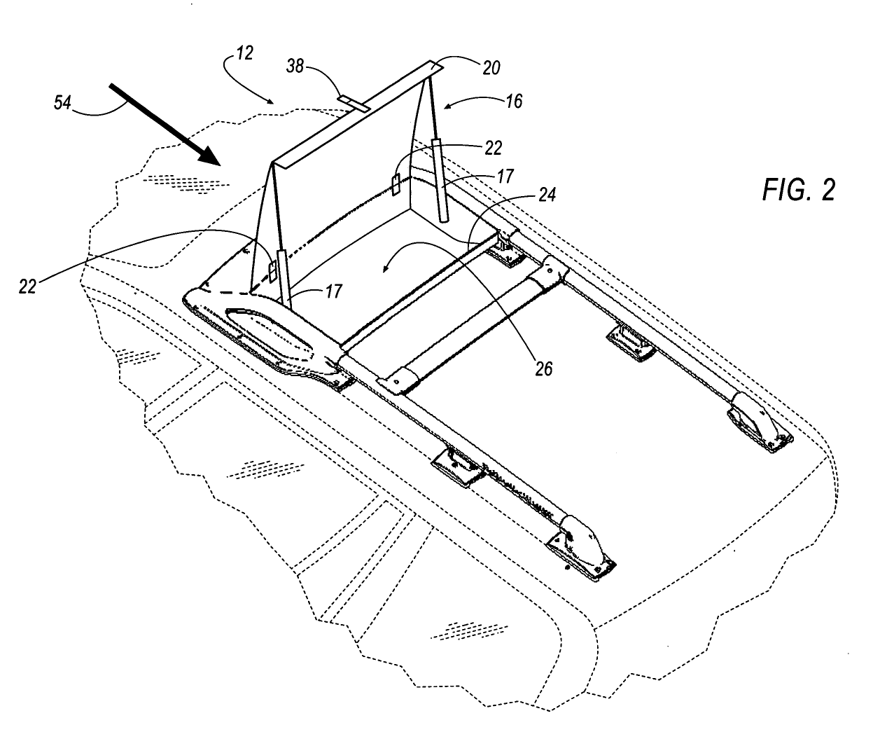

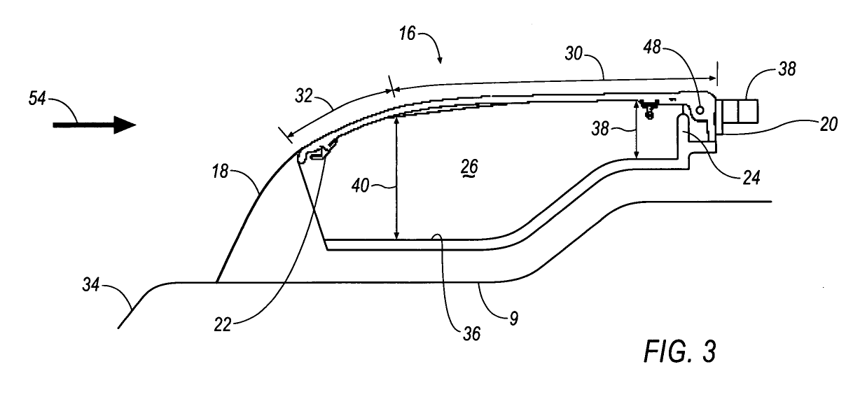

With reference to FIGS. 1 and 2, an embodiment of the storage bin 12 is shown and described. In FIG. 1, the storage bin 12 is shown including a closure 16 adjacent to a windward portion 18. The closure 16 is a door, hatch or other access panel that allows access into an interior portion of the storage bin 12. The windward portion 18, in an embodiment, is a sloped region, preferably positioned on the windward side of the vehicle 10, that assists in aerodynamics and drag reduction of the storage bin 12. In an embodiment, as shown in FIG. 3, the windward portion 18 has a larger slope with respect to the presumed wind direction 54 than does the closure 16 when in a closed configuration. Also, in an embodiment, the angular orientation of the windward portion 18 substantially matches an angular orientation of the windshield 34 of the vehicle 10. In this fashion, the windshield 34, windward portion 18 and closure 16 are able to cooperate to reduce an overall wind resistance of the roof rack system 8. In another embodiment, as shown in FIG. 3, the closure 16 has a first portion 30 that is substantially parallel to the presumed wind direction 54 and a second portion 32 that has a steeper angle with respect to the presumed wind direction 54. Of course, these angular orientations may include curved surfaces, non-aerodynamic surfaces or other configurations. The different configurations, described above, provide enhanced aerodynamic characteristics of the roof rack system 8. One skilled in the art will also readily recognize other aerodynamic configurations and shapes that may be used in connection with the embodiments of the present invention, and the embodiments of the present invention are not limited to that disclosed herein. Thus, it will be understood that the surfaces described above may also be constructed in a non-aerodynamic fashion.

In an embodiment, the storage bin 12 is positioned between the bars of the roof rack 14 such that the closure 16 is flush with or set below the roof rack 14 with respect to a normal orientation of the roof rack 14 and the storage bin 12. Of course, one skilled in the art will recognize that the positioning of the storage bin 12 with respect to the roof rack 14 may be any configuration and is not limited to that disclosed herein.

With reference to FIG. 2, the closure 16 is shown positioned in an open configuration with respect to the storage bin 12. As can be seen, in an embodiment, the closure 16 is connected to the bin 12 by hinges 22. The hinges 22 allow the closure 16 to rotatably move between an open position shown in FIG. 2 and the closed position shown in FIG. 1. Cylinders 17 may be provided to assist in opening or resisting closure of the closure 16. The open position, as shown in FIG. 2, allows access to an interior portion 26 of the storage bin 12. Likewise, when in the closed position 16, items are prevented from falling out of or being removed from the interior portion 26.

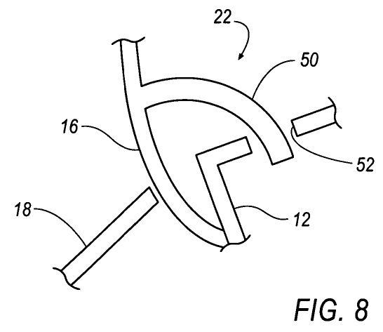

With reference to FIG. 8, one embodiment of hinges 22 is described in greater detail. In FIG. 8, hinges 22 and are generally formed by cooperation of extension 50, closure 16, windward portion 18 and an aperture 52 in the storage bin 12. Movement of the extension 50 through the aperture 52 allows the closure 16 to rotate between the open and closed position. Similarly, interference between the closure 16, windward portion 18 and an outer wall of the bin storage bin 12 provides a natural over travel stop when opening the closure 16. Additionally, when in an open most position, closure 16 may be moved vertically upward to remove extension 50 from the aperture 52 and thereby remove the closure 16 from the storage bin 12. One skilled in the art will readily recognize other hinging mechanisms that may be used with the present invention.

In FIGS. 1 and 3, an embodiment of the closure 16 is shown when in a closed configuration. As shown in FIG. 3, the storage bin 12 includes a face 24. The closure 16 includes a leeward side 20 and a handle 38 for a latching mechanism (as will be discussed). As shown in FIG. 3, when the closure 16 is in the closed position, the leeward side 20 is adjacent to the face 24. When closed, the handle 38 can then be turned to actuate a latching mechanism (as will be discussed).

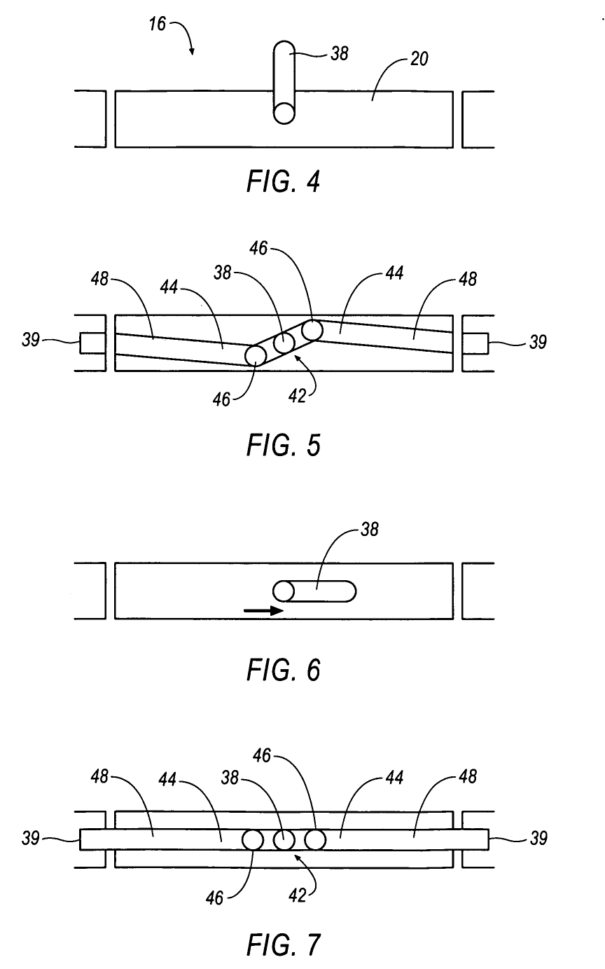

With reference to FIGS. 4-7, the latching mechanism according to one embodiment of the invention is shown and described. Although the latching mechanism is depicted with respect to FIGS. 4-7, one skilled in the art will readily recognize that other latching mechanisms may be employed in connection with the embodiments of the present invention, and the embodiments of the present invention are not limited to that disclosed herein.

In FIG. 4, closure 16 is shown in a closed position with the handle 38 in an unlatched state. Here, the handle 38 is shown in an up-position, which places the latching mechanism in an unlatched state. Of course, it will be understood that other configurations for handle 38 may be used to place the latching mechanism in an unlatched state. Additionally, other mechanisms besides a handle may also be used in connection with embodiments of the present invention.

FIG. 5 illustrates a schematic view of an embodiment for the latching mechanism while in an unlatched state. The mechanical components include a rotatable link, centered about the handle 38, that is connected to arms 44 by pivot points 46. The arms 44 are reciprocally disposed to move in and out of apertures 39. In the unlatched state, rotatable link 42 is angled with respect to the Figure to position arms 44 in a retracted state from apertures 39.

FIG. 6 illustrates the handle 38 positioned to latch the latching mechanism. Similar to above description, other configurations may be used to latch the latching mechanism. In FIG. 7, an embodiment of the mechanical components of the latching mechanism is shown in the latched state. Here, rotatable link 46 is shown as horizontal with respect to the FIG. to position arms 44 in an inserted state with respect to apertures 39.

Of course, one skilled in the art will readily recognize that alternative latching mechanisms may be employed other than those described in the embodiments of the present invention.

Referring again to FIG. 3, an embodiment of the storage bin 12 includes a bottom surface 36 positioned adjacent to the roof portion 9. Here, the bottom surface 36 is shaped to substantially match the shape of the roof portion 9. In an embodiment, the roof portion 9 of the vehicle 10 has an elevated region which transitions into a lower region. For example, at a point along the elevated region, a shallow depth, such as depth 38, is provided between the closure 16 and the bottom surface 36. At a point along the lower region, a relatively deeper depth, such as depth 40, is provided between the closure 16 and the bottom surface 36. As can be seen, by providing a bottom surface 36 that is shaped to substantially match the shape of the roof portion 9, an amount of space in the interior portion 26 is maximized. Also, it will be understood that depths 38 and 40 are merely representative depths and the embodiments of the present invention is not limited to the specific depths, floor and roof shapes disclosed herein.

Referring now to FIGS. 1-8, an operation of an embodiment of the present invention is described. When the closure 16 is to be opened to allow access to the interior portion 26, handle 38 is operated as described with respect to FIGS. 4-7. The closure 16 is then lifted and moved to the position shown in FIG. 2 for exposing the interior portion 26. Cylinders 17 then act to support the closure 16 from falling closed. Additionally, as shown in FIG. 8, windward portion 18 storage bin 12 cooperate to prevent closure 16 from over travel. When closing, the closure 16 is moved back to the position shown in FIG. 1 and the latching mechanism is actuated to latch the closure 16 into place.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A roof rack system for a vehicle, comprising:
a vehicle roof rack;
a storage bin connected to the vehicle roof rack, wherein the storage bin comprises:
a bin portion having an opening and an interior portion; and
a closure member having a hinge portion such that the closure member selectively covers the opening and provides access to the interior portion of the bin portion;
wherein the hinge portion is positioned in an upwind location with respect to a presumed wind direction such that the closure member opens towards the presumed wind direction to allow access into the interior portion.

2. The roof rack system according to claim 1, further comprising:
a latching mechanism detachably connecting the closure member to the bin portion;
wherein the hinge member and the latching mechanism cooperate to selectively cover the opening and detachably connect the closure member to the bin portion.

3. The roof rack system according to claim 2, further comprising:
a leeward side of the closure member extending substantially perpendicular to the presumed wind direction; and
a mating face on the bin portion extending substantially vertical with respect to the presumed wind direction;
wherein the mating face is adjacent to the leeward side when the closure member is in a closed position.

4. The roof rack system according to claim 2, wherein the storage bin further comprises:
a bottom portion adapted to be positioned adjacent to a roof of the vehicle; and
a windward portion adjacent to and upwind of the closure member with respect to the presumed wind direction;
wherein the windward portion has an aerodynamic shape that is adapted to reduce wind drag from wind coming from the presumed wind direction.

5. The roof rack system according to claim 4, wherein the bottom portion further comprises:
at least a first surface defining a first depth of the interior portion; and
at least a second surface defining a second depth of the interior portion;
wherein the first surface and the second surface are adapted to substantially correspond to a shape of a roof of the vehicle.

6. The roof rack system according to claim 2, wherein:
the windward portion has a larger angle than the closure member with respect to the presumed wind direction; and
the windward portion and closure member cooperate to form an aerodynamic shape with respect to the presumed wind direction.

7. The roof rack system according to claim 6, wherein:
the windward portion is adapted to connect to a roof of the vehicle at a location adjacent to a windshield of the vehicle; and
the windward portion has a slope substantially equal to a slope of the windshield.

8. The roof rack system according to claim 6, wherein the closure member further comprises:
a first portion that is substantially planar and which extends substantially parallel to the presumed wind direction; and
a second portion positioned at an upwind location from the first portion with respect to the presumed wind direction, wherein the second portion has a greater angle than the first portion with respect to the presumed wind direction;
wherein the first portion and the second portion cooperate to form an aerodynamic shape with respect to the presumed wind direction.

9. The roof rack system according to claim 8, wherein the closure member is positioned substantially flush with or below a level of the roof rack with respect to a normal orientation of the roof rack and the bin portion.

10. A storage bin for a roof rack system, comprising:
a bin portion having an opening and an interior portion; and
a closure member having a hinge portion such that the closure member selectively covers the opening and provides access to the interior portion of the bin portion;
wherein the hinge portion is positioned in an upwind location with respect to a presumed wind direction such that the closure member opens towards the presumed wind direction to allow access into the interior portion.

11. The storage bin according to claim 10, further comprising:
a latching mechanism detachably connecting the closure member to the bin portion;
wherein the hinge member and the latching mechanism cooperate to selectively cover the opening and detachably connect the closure member to the bin portion.

12. The storage bin according to claim 11, further comprising:
a leeward side of the closure member extending substantially perpendicular to the presumed wind direction; and
a mating face on the bin portion extending substantially vertical with respect to the presumed wind direction;
wherein the mating face is adjacent to the leeward side when the closure member is in a closed position.

13. The storage bin according to claim 11, wherein the storage bin further comprises:
a bottom portion adapted to be positioned adjacent to a roof of the vehicle; and
a windward portion adjacent to and upwind of the closure member with respect to the presumed wind direction;
wherein the windward portion has an aerodynamic shape that is adapted to reduce wind drag from wind coming from the presumed wind direction.

14. The storage bin according to claim 13, wherein the bottom portion further comprises:
at least a first surface defining a first depth of the interior portion; and
at least a second surface defining a second depth of the interior portion;
wherein the first surface and the second surface are adapted to substantially correspond to a shape of a roof of a vehicle.

15. The storage bin according to claim 11, wherein:
the windward portion has a larger angle than the closure member with respect to the presumed wind direction;
the windward portion and closure member cooperate to form an aerodynamic shape with respect to the presumed wind direction.

16. The storage bin according to claim 15, wherein:
the windward portion is adapted to connect to a roof of the vehicle at a location adjacent to a windshield of the vehicle; and
the windward portion has a slope substantially equal to a slope of the windshield.

17. The storage bin according to claim 15, wherein the closure member further comprises:
a first portion that is substantially planar and which extends substantially parallel to the presumed wind direction; and
a second portion positioned at an upwind location from the first portion with respect to the presumed wind direction, wherein the second portion has a greater angle than the first portion with respect to the presumed wind direction;
wherein the first portion and the second portion cooperate to form an aerodynamic shape with respect to the presumed wind direction.

18. The storage bin according to claim 17, further comprising a means for latching the closure member in a closed position.

19. A vehicle comprising:
a roof rack attached to a roof of the vehicle;
a storage bin connected to the vehicle roof rack, wherein the storage bin comprises:
a bin portion having an opening and an interior portion; and
a closure member having a hinge portion such that the closure member selectively covers the opening and provides access to the interior portion of the bin portion;
wherein the hinge portion is positioned in an upwind location with respect to a presumed wind direction such that the closure member opens towards the presumed wind direction to allow access into the interior portion.

20. The vehicle according to claim 19, further comprising:
a latching mechanism detachably connecting the closure member to the bin portion;
wherein the hinge member and the latching mechanism cooperate to selectively cover the opening and detachably connect the closure member to the bin portion.

21. The vehicle according to claim 20, further comprising:
a leeward side of the closure member extending substantially perpendicular to the presumed wind direction;
a mating face on the bin portion extending substantially vertical with respect to the presumed wind direction;
wherein the mating face is adjacent to the leeward side when the closure member is in a closed position.

22. The vehicle according to claim 20, wherein the storage bin further comprises:
a bottom portion adapted to be positioned adjacent to the roof of the vehicle; and
a windward portion adjacent to and upwind of the closure member with respect to the presumed wind direction;
wherein the windward portion has an aerodynamic shape that is adapted to reduce wind drag from wind coming from the presumed wind direction.

23. The vehicle according to claim 22, wherein the bottom portion further comprises:
at least a first surface defining a first depth of the interior portion; and
at least a second surface defining a second depth of the interior portion;
wherein the first surface and the second surface are adapted to substantially correspond to a shape of the roof of the vehicle.

24. The vehicle according to claim 20, wherein:
the windward portion has a larger angle than the closure member with respect to the presumed wind direction; and
the windward portion and closure member cooperate to form an aerodynamic shape with respect to the presumed wind direction.

25. The vehicle according to claim 24, wherein:
the windward portion is adapted to connect to the roof of the vehicle at a location adjacent to a windshield of the vehicle; and
the windward portion has a slope substantially equal to a slope of the windshield.

26. The vehicle according to claim 24, wherein the closure member further comprises:
a first portion that is substantially planar and which extends substantially parallel to the presumed wind direction; and
a second portion positioned at an upwind location from the first portion with respect to the presumed wind direction, wherein the second portion has a greater angle than the first portion with respect to the presumed wind direction;
wherein the first portion and the second portion cooperate to form an aerodynamic shape with respect to the presumed wind direction.

27. The vehicle according to claim 19, wherein the closure member is positioned substantially flush with or below a level of the roof rack with respect to a normal orientation of the roof rack and the bin portion.
